(19) United States
(12) Patent Application Publication
(10) Pub. No.: US 2015/0092994 A1
(43) Pub. Date: Apr. 2, 2015

(54) ELIGIBLE OPERATOR DETERMINATION DEVICE AND ELIGIBLE OPERATOR DETERMINATION METHOD

(71) Applicants: Koji MASUDA, Kanagawa (JP); Toshiaki TOKITA, Kanagawa (JP); Masahiro ITOH, Kanagawa (JP); Hiroaki TANAKA, Kanagawa (JP); Yasuhiro NIHEI, Kanagawa (JP); Takeshi UEDA, Tokyo (JP); Kenichi TAKANASHI, Kanagawa (JP)

(72) Inventors: Koji MASUDA, Kanagawa (JP); Toshiaki TOKITA, Kanagawa (JP); Masahiro ITOH, Kanagawa (JP); Hiroaki TANAKA, Kanagawa (JP); Yasuhiro NIHEI, Kanagawa (JP); Takeshi UEDA, Tokyo (JP); Kenichi TAKANASHI, Kanagawa (JP)

(73) Assignee: RICOH COMPANY, LTD., Tokyo (JP)

(21) Appl. No.: 14/489,634

(22) Filed: Sep. 18, 2014

(30) Foreign Application Priority Data
Sep. 27, 2013 (JP) 2013-200718

(51) Int. Cl. G06K 9/00; G06T 7/20

(52) U.S. Cl. CPC G06K 9/00845; G06T 7/20; G06K 9/00375; G06T 2207/10028; G06T 2207/30196; G06T 2207/30268
USPC 382/107

(57) ABSTRACT

An eligible operator determination device includes a three-dimensional light measurement unit configured to measure three-dimensional coordinates of respective parts in a visual field including a posture of a monitor target operating a device; a motion recognition unit configured to recognize a predetermined ineligible motion from a measurement result obtained by the three-dimensional light measurement unit; and an ineligibility coping unit configured to execute a predetermined process according to the predetermined ineligible motion, when the predetermined ineligible motion is recognized by the motion recognition unit.

### BACKGROUND OF THE INVENTION

1. Field of the Invention

The present invention relates to a technology of determining the movement of a human being or a robot.

2. Description of the Related Art

Appropriate movements are required for operating (maneuvering) devices. For example, in the case of a vehicle, when an inappropriate movement is taken when driving (operating/maneuvering) the vehicle, an accident may happen. Therefore, a driver's license is issued in advance to a person capable of driving appropriately, and a person without a driver's license is prohibited from driving. A driver's license proves that the person is eligible to drive a vehicle.

However, at the moment when the person actually drives a vehicle, it is difficult to determine whether the person is eligible. For example, even if the person has a driver's license, the person may have drunk alcohol, or the person may be lacking sleep (in a sleepy state).

As for the case of alcohol, there is already known a system for preventing driving under the influence of alcohol, in which an alcohol detection device is provided in the vehicle.

However, when a person who has not drunk alcohol starts the engine of vehicle, and then switches places with a person who has drunk alcohol, this system cannot prevent the ineligible person from driving.

Meanwhile, for the purpose of preventing an ineligible person from performing the maneuvering, there is proposed an ineligible maneuvering prevention system, such that when the operator for performing the maneuvering is switched to another person after the driving source of the maneuvering target has been started, but the operator after the switching is not eligible for the maneuvering, the ineligible operator is prevented from performing the maneuvering (see, for example, Patent Document 1).

As described above, the conventional system detects alcohol and determines whether the person is eligible (has not drunk alcohol) or ineligible (has drunk alcohol), and determines whether an eligible person has switched with an ineligible person.

This system determines whether the person is eligible before actually driving a vehicle, but does not determine whether this person is eligible at the moment when the person actually drives the vehicle.

Therefore, the conventional system has been insufficient in terms of preventing inappropriate operations when driving a vehicle and preventing an accident before it happens.

In the above example, the driving of a vehicle is described; however, the same problem arises in operating various kinds of devices other than a vehicle. Furthermore, the target is not limited to the human being; the same applies to a robot that imitates movements of a human being.

Patent Document 1: Japanese Laid-Open Patent Publication No. 2008-310454

### SUMMARY OF THE INVENTION

The present invention provides an eligible operator determination device and an eligible operator determination method, in which one or more of the above-described disadvantages are eliminated.

According to an aspect of the present invention, there is provided an eligible operator determination device including a three-dimensional light measurement unit configured to measure three-dimensional coordinates of respective parts in a visual field including a posture of a monitor target operating a device; a motion recognition unit configured to recognize a predetermined ineligible motion from a measurement result obtained by the three-dimensional light measurement unit; and an ineligibility coping unit configured to execute a predetermined process according to the predetermined ineligible motion, when the predetermined ineligible motion is recognized by the motion recognition unit.

According to an aspect of the present invention, there is provided an eligible operator determination method including measuring three-dimensional coordinates of respective parts in a visual field including a posture of a monitor target operating a device; recognizing a predetermined ineligible motion from a measurement result obtained at the measuring; and executing a predetermined process according to the predetermined ineligible motion, when the predetermined ineligible motion is recognized at the recognizing.

According to an aspect of the present invention, there is provided a non-transitory computer-readable recording medium storing a program that causes a computer, which constitutes an eligible operator determination device, to execute a process including measuring three-dimensional coordinates of respective parts in a visual field including a posture of a monitor target operating a device; recognizing a predetermined ineligible motion from a measurement result obtained at the measuring; and executing a predetermined process according to the predetermined ineligible motion, when the predetermined ineligible motion is recognized at the recognizing.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration example of an eligible operator determination device according to an embodiment of the present invention;

FIGS. 2A through 2C illustrate configuration examples of a three-dimensional light measurement unit;

FIG. 3 illustrates an arrangement example of an optical system of the three-dimensional light measurement unit;

FIG. 4 illustrates a configuration example of a motion recognition unit;

FIG. 5 is a flowchart illustrating a process example according to an embodiment; and

FIG. 6 indicates examples of ineligible movements.

### DETAILED DESCRIPTION OF THE PREFERRED EMBODIMENTS

A description is given, with reference to the accompanying drawings, of embodiments of the present invention.

### Configuration

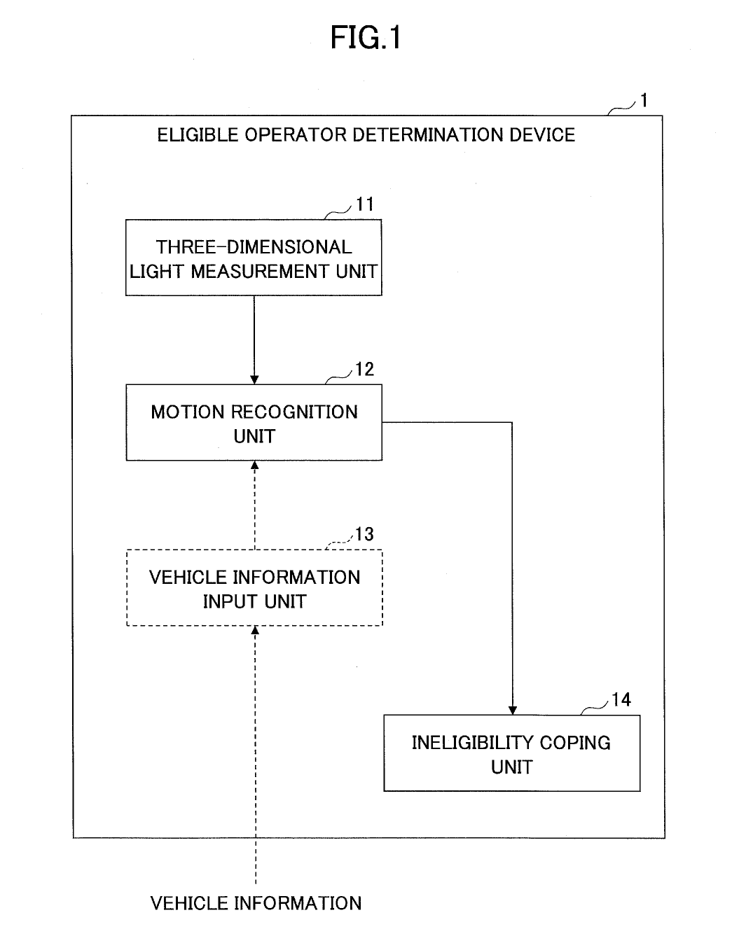

FIG. 1 illustrates a configuration example of an eligible operator determination device 1 according to an embodiment of the present invention. Note that a description is given of an example where the present embodiment is applied to the driving of a vehicle; however, the present embodiment is obviously applicable to other targets.

In FIG. 1, the eligible operator determination device 1 includes a three-dimensional light measurement unit 11, a motion recognition unit 12, a vehicle information input unit 13, and an ineligibility coping unit 14. The three-dimensional light measurement unit 11 (excluding optical system), the motion recognition unit 12, the vehicle information input unit 13, and the ineligibility coping unit 14 are function units that are mainly constituted by software (computer programs). Note that the vehicle information input unit 13 may be omitted when vehicle information is not used.

The three-dimensional light measurement unit 11 includes a visual field directed to a monitor target, and has a function of measuring three-dimensional coordinates of the respective parts within the visual field. As the three-dimensional light measurement unit 11, as described below, a method of calculating the three-dimensional coordinates of the respective points in an image within the visual field from a speckle pattern according to coherent light; a method of calculating the three-dimensional coordinates of the respective points in an image within the visual field according to the parallax of two images that have been taken; or a method of calculating three-dimensional coordinates of the respective points within the visual field according to the time difference between a scan light and a reflected light of the scan light, may be used.

The motion recognition unit 12 has a function of recognizing an ineligible motion from the measurement results of the three-dimensional light measurement unit 11. An ineligible motion is a predetermined motion of a monitor target (driver) that is suspected to be ineligible for operating (driving).

The vehicle information input unit 13 has a function of acquiring vehicle information from the vehicle main body (vehicle body), when vehicle information is used for the motion recognition by the motion recognition unit 12. The vehicle information includes vehicle speed information, acceleration information, steering wheel operation information, brake operation information, inter-vehicular distance information, and surrounding vehicle information.

The ineligibility coping unit 14 has a function of executing a predetermined process according to an ineligible motion, when the motion recognition unit 12 recognizes an ineligible motion.

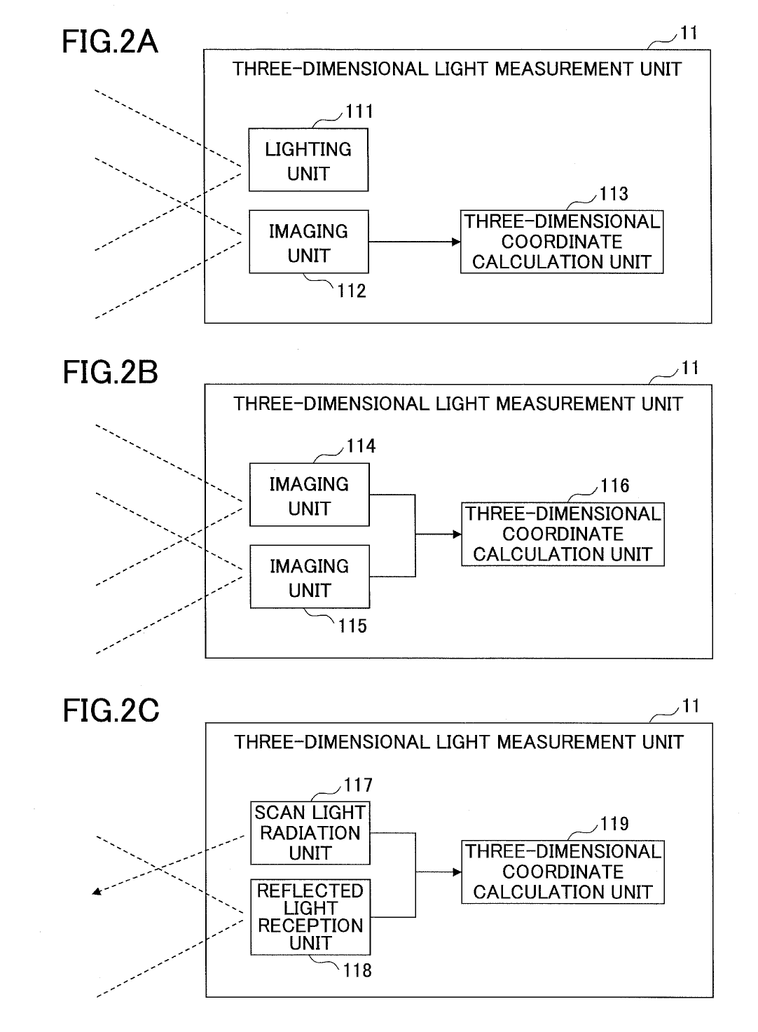

FIGS. 2A through 2C illustrate configuration examples of the three-dimensional light measurement unit 11. FIG. 2A illustrates a configuration for performing the method of calculating the three-dimensional coordinates of the respective points in an image within the visual field from a speckle pattern according to coherent light. The three-dimensional light measurement unit 11 includes a lighting unit 111 for radiating a coherent light to a predetermined visual field range, an imaging unit 112 for taking an image of a predetermined visual field range, and a three-dimensional coordinate calculation unit 113 for calculating three-dimensional coordinates of the respective points on an image from a speckle pattern included in the image obtained by the imaging unit 112. A description of the three-dimensional measurement using a speckle pattern is described in detail in Japanese National Publication of International Patent Application No. 2009-531655.

FIG. 2B illustrates a configuration of the three-dimensional light measurement unit 11 for performing the method of calculating the three-dimensional coordinates of the respective points in an image within the visual field according to the parallax of two images that have been taken. The three-dimensional light measurement unit 11 includes two imaging units 114, 115 which are for taking images within a predetermined visual field range and which are spaced apart by a predetermined distance, and a three-dimensional coordinate calculation unit 116 for calculating three-dimensional coordinates of the respective points in an image from the parallax of two images that have been taken by the imaging units 114, 115. In a case where the visual field is sufficiently bright in the waveband where the image is taken, there is no need to provide a lighting unit; however, a lighting unit may be provided if the brightness may be insufficient.

FIG. 2C illustrates a configuration of the three-dimensional light measurement unit 11 for performing the method of calculating three-dimensional coordinates of the respective points within the visual field according to the time difference between scan light and a reflected light of the scan light. The three-dimensional light measurement unit 11 includes a scan light radiation unit 117 for radiating a scan light to a predetermined visual field range, a reflected light reception unit 118 for receiving the scan light reflected from a target object, and a three-dimensional coordinate calculation unit 119 for calculating three-dimensional coordinates of the respective points in a predetermined visual field range according to the time difference between the scan light and the reflected light of the scan light.

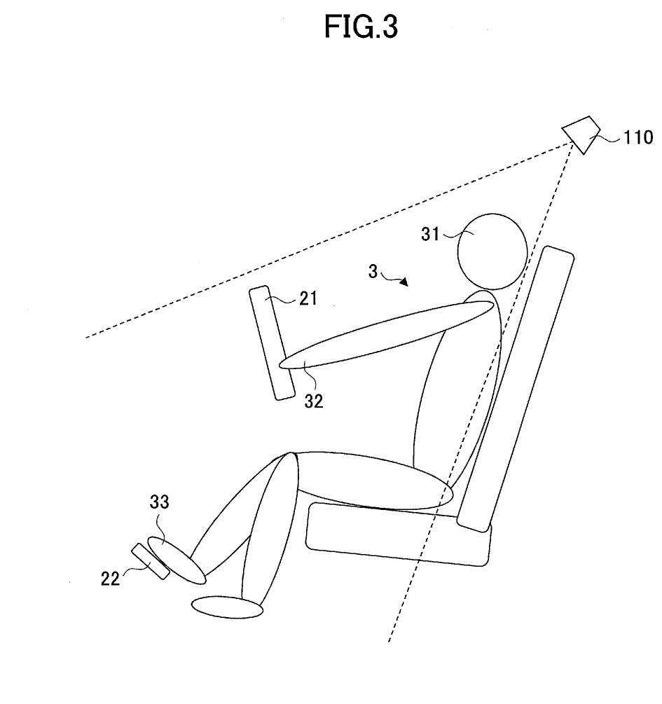

FIG. 3 illustrates an arrangement example of an optical system of the three-dimensional light measurement unit 11. In the present embodiment, the targets of operation recognition are a head 31 of a driver 3, a hand 32 holding a steering wheel 21, and a foot 33 stepping on a pedal 22 of a brake or an accelerator. Therefore, for example, by providing an optical system 110 of the three-dimensional light measurement unit 11 on a ceiling part behind the head 31 of the driver 3, it is possible to perform the measurement with a single optical system 110. Note that a plurality of optical systems 110 may be provided, so as to be arranged for different visual fields.

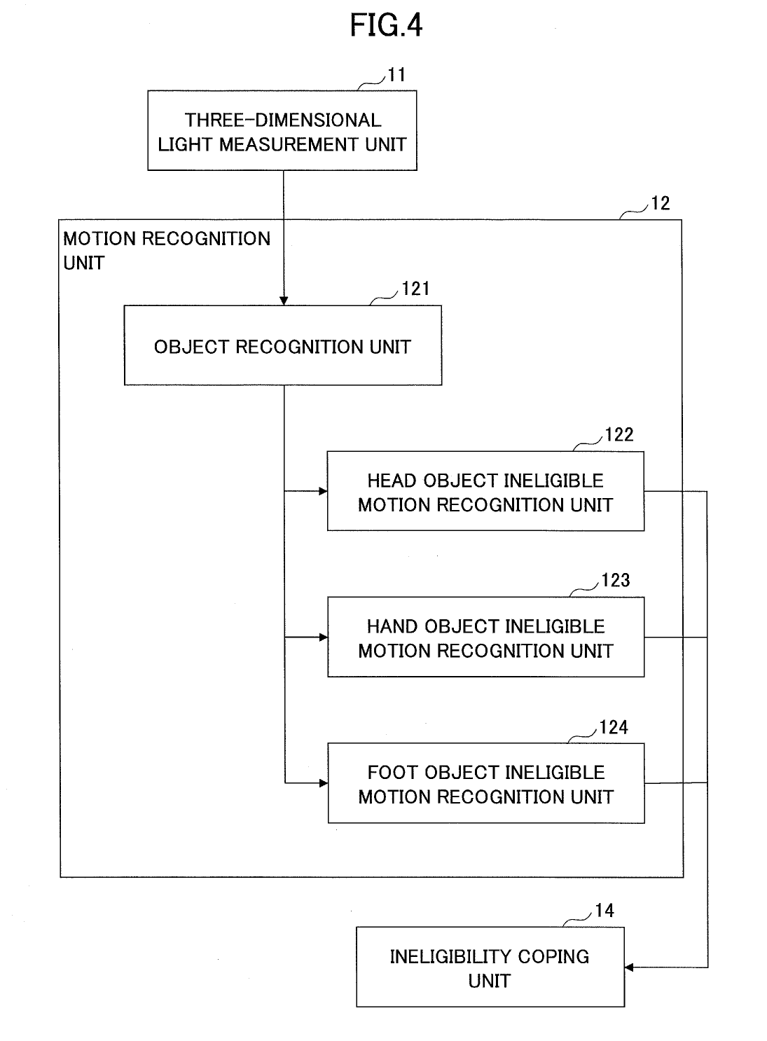

FIG. 4 illustrates a configuration example of the motion recognition unit 12.

In FIG. 4, the motion recognition unit 12 includes an object recognition unit 121, a head object ineligible motion recognition unit 122, a hand object ineligible motion recognition unit 123, and a foot object ineligible motion recognition unit 124.

The object recognition unit 121 has a function of recognizing objects such as the head, the hand, and the foot of a driver, and according to need, a steering wheel and a pedal, in an image including three-dimensional coordinate information in the visual field output from the three-dimensional light measurement unit 11.

The head object ineligible motion recognition unit 122 has a function of recognizing an ineligible motion of the head object recognized by the object recognition unit 121, and sending a notification indicating the recognition result to the ineligibility coping unit 14.

The hand object ineligible motion recognition unit 123 has a function of recognizing an ineligible motion of the hand object, and according to need, the steering wheel object, recognized by the object recognition unit 121, and sending a notification indicating the recognition result to the ineligibility coping unit 14.

The foot object ineligible motion recognition unit 124 has a function of recognizing an ineligible motion of the foot object, and according to need, the pedal object (brake pedal object, accelerator pedal object), recognized by the object recognition unit 121, and sending a notification indicating the recognition result to the ineligibility coping unit 14.

### Operation

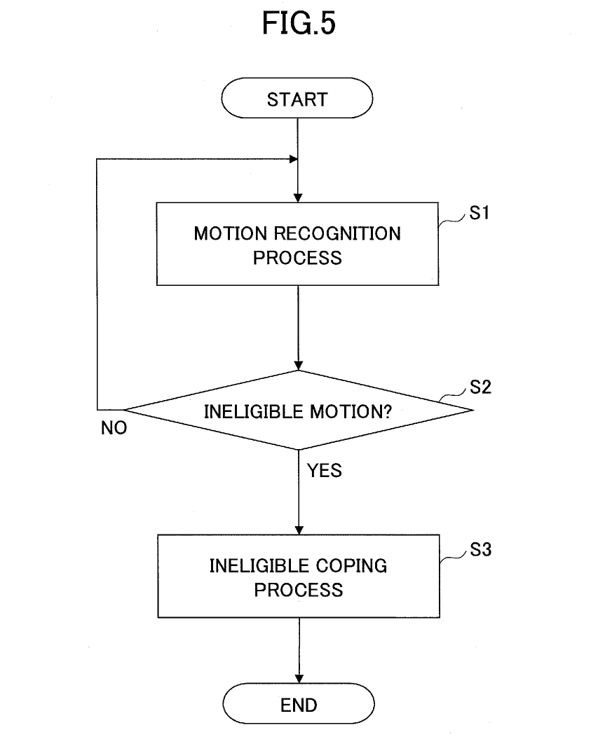

FIG. 5 is a flowchart illustrating a process example according to the embodiment described above.

In FIG. 5, when the process starts, the motion recognition unit 12 performs motion recognition based on the measurement result of the three-dimensional light measurement unit 11 (step S1).

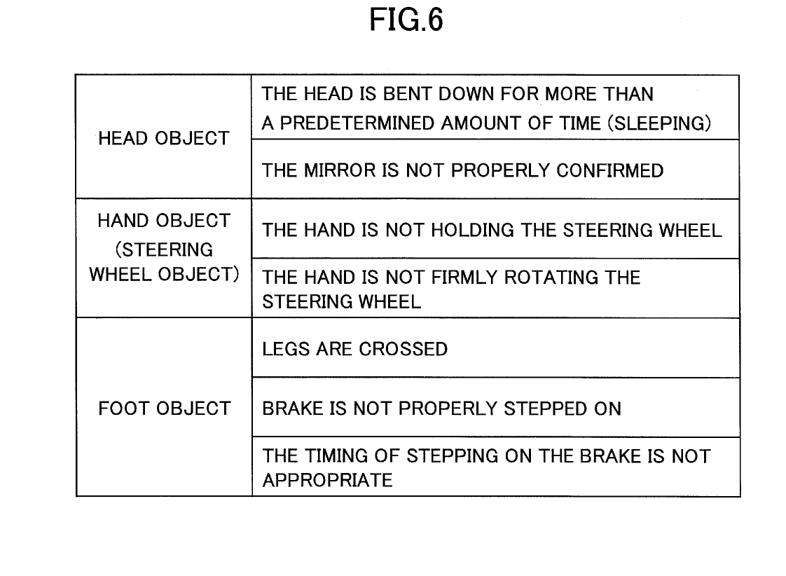

FIG. 6 indicates examples of ineligible movements. The head object ineligible motion recognition unit 122, the hand object ineligible motion recognition unit 123, and the foot object ineligible motion recognition unit 124 of the motion recognition unit 12 recognize the following motions as ineligible motions.

### Head Object Ineligible Motion Recognition Unit 122:

The head is bent down for more than a predetermined amount of time (sleeping).

This can be recognized when the axial line (line extending from neck toward vertex of head) of the head object is tilted for a predetermined amount of time.

The mirror is not properly confirmed.

This can recognized when the motion of the head object does not match the surrounding vehicle information and the steering wheel operation information (lane change information) of the vehicle information.

### Hand Object Ineligible Motion Recognition Unit 123:

The hand is not holding the steering wheel.

This can be recognized when the hand object is not in contact with the steering wheel object.

The hand is not firmly rotating the steering wheel.

This can be recognized when the motion of the hand object is blurring excessively.

Furthermore, can be recognized when the motion of the hand does object not match the motion of the steering wheel (detect motion of steering wheel from vehicle information, or from the motion of the steering wheel).

### Foot Object Ineligible Motion Recognition Unit 124

Legs are crossed.

This can be recognized when foot object is at a position far from the floor, the brake pedal object, or the accelerator pedal object, or the foot is on the seat.

Brake is not properly stepped on.

This can be recognized when foot object repeatedly moves between the brake pedal object and the accelerator pedal object within a short period of time (hesitation occurs).

Furthermore, can be recognized when the motion of foot object stepping into the brake pedal object does not match brake information and/or vehicle speed information of the vehicle information.

The timing of stepping on the brake is not appropriate.

This can be recognized when motion of foot object stepping into the brake pedal does not match the inter-vehicular distance information (interval between present vehicle and front vehicle) of the vehicle information.

Referring back to FIG. 5, when an ineligible motion is not recognized as a result of the motion recognition (NO in step S2), the process is repeated from the motion recognition process (step S1).

When an ineligible motion is recognized as a result of the motion recognition (YES in step S2), the ineligibility coping unit 14 executes a predetermined process according to the ineligible motion (step S3). Specifically, the following processes are performed.

When the vehicle is stopped, restrict the vehicle from starting to move.

When the vehicle is moving, cause the vehicle to gradually decelerate, stop, and subsequently restrict the vehicle from starting to move.

Send an alarm to the driver.

Send mails and messages to related people.

Communicate a message to the traffic lights.

Subsequently, according to need, the process is repeated from the motion recognition process (step S1).

### Overview

As described above, according to the present embodiment, at the moment when the operator actually operates the device, it is determined whether the operator is eligible, and a dangerous state is prevented before happening.

The eligible operator determination device and the eligible operator determination method are not limited to the specific embodiments described herein, and variations and modifications may be made without departing from the spirit and scope of the present invention. That is to say, the eligible operator determination device and the eligible operator determination method are not limited to the details of the specific examples and the attached drawings.

The present application is based on and claims the benefit of priority of Japanese Priority Patent Application No. 2013-200718, filed on Sep. 27, 2013, the entire contents of which are hereby incorporated herein by reference.

What is claimed is:

1. An eligible operator determination device comprising:
a three-dimensional light measurement unit configured to measure three-dimensional coordinates of respective parts in a visual field including a posture of a monitor target operating a device;
a motion recognition unit configured to recognize a predetermined ineligible motion from a measurement result obtained by the three-dimensional light measurement unit; and
an ineligibility coping unit configured to execute a predetermined process according to the predetermined ineligible motion, when the predetermined ineligible motion is recognized by the motion recognition unit.

2. The eligible operator determination device according to claim 1, wherein
the motion recognition unit acquires, from the device, information indicating a state of the device, and recognizes the predetermined ineligible motion.

3. The eligible operator determination device according to claim 1, wherein
the motion recognition unit recognizes, from the measurement result obtained by the three-dimensional light measurement, objects corresponding to a head, a hand, and a foot, when the monitor target is a human being and the operated device is a vehicle, and recognizes whether a motion of each of the objects corresponds to the predetermined ineligible motion.

4. An eligible operator determination method comprising:
measuring three-dimensional coordinates of respective parts in a visual field including a posture of a monitor target operating a device;
recognizing a predetermined ineligible motion from a measurement result obtained at the measuring; and
executing a predetermined process according to the predetermined ineligible motion, when the predetermined ineligible motion is recognized at the recognizing.

5. A non-transitory computer-readable recording medium storing a program that causes a computer, which constitutes an eligible operator determination device, to execute a process comprising:
measuring three-dimensional coordinates of respective parts in a visual field including a posture of a monitor target operating a device;
recognizing a predetermined ineligible motion from a measurement result obtained at the measuring; and
executing a predetermined process according to the predetermined ineligible motion, when the predetermined ineligible motion is recognized at the recognizing.
